(19) United States
(12) Patent Application Publication
(10) Pub. No.: US 2025/0384663 A1
(43) Pub. Date: Dec. 18, 2025

(54) INFLUENTIAL DATA SELECTION FOR NEURAL NETWORK TRAINING

(71) Applicant: GDM Holding LLC, Mountain View, CA (US)

(72) Inventors: Zhiwei Deng, Mountain View, CA (US); Tao Li, San Jose, CA (US); Yang Li, Palo Alto, CA (US)

(21) Appl. No.: 19/238,113

(22) Filed: Jun. 13, 2025

Related U.S. Application Data
(60) Provisional application No. 63/660,438, filed on Jun. 14, 2024.

(51) Int. Cl. G06V 10/764; G06V 10/82

(52) U.S. Cl. CPC G06V 10/764; G06V 10/82

(57) ABSTRACT

Systems, methods, and apparatus, including computer programs encoded on computer storage media for selecting, from a training data set of training examples, a subset of training examples that will be used for training a neural network by selecting the subset of training examples whose combined gradients over time match a target gradient trajectory.

### CROSS-REFERENCE TO RELATED APPLICATIONS

This application claims priority to U.S. Provisional Application No. 63/660,438, filed on Jun. 14, 2024. The disclosure of the prior application is considered part of and is incorporated by reference in the disclosure of this application.

### BACKGROUND

This specification relates to training machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that can select, from a training data set of training examples, a subset of training examples that will be used for training a neural network. More specifically, the system can select the subset of training examples by selecting the subset of training examples whose combined gradients over time match a target gradient trajectory.

Particular embodiments of the subject matter described in this specification can be implemented so as to realize one or more of the following advantages.

Large language models can encompass an enormous amount of knowledge acquired through a pre-training corpus. However, choosing and utilizing data sets for both quickly adapting models given a fixed budget and maximizing the performance of a model for a targeted task can be difficult. Gradient information, which reflects the optimization process and has direct correlation with final model performance, can be a common criterion for data selection. However, how to effectively utilize gradient information for the actual selection process is still a challenging problem. Existing methods are built upon either individual sample rankings or an inefficient matching process, leading to suboptimal performance or scaling up issues. Top-k selection can be fast and the most straightforward way, but its performance is often suboptimal compared to joint selection.

The techniques disclosed in this specification can perform training data selection through matching the trajectory of a subset of training examples with the trajectory of a target data set on a gradient subspace. More specifically, the techniques can select a subset of training data through a pursuit process of gradient trajectories on a target subspace during warmup training of a model. The techniques described can project the gradients onto a small subspace for the optimization process, significantly reducing the memory cost during selection, and de-duplicate training examples through a joint data selection technique to train a model more robustly. That is, the techniques described in this specification determine a subset of training examples in a more computationally and memory efficient manner, while determining training examples that more robustly train a model for higher quality outputs.

The details of one or more embodiments of the subject matter will become apparent from the description, drawings, and the claims.

Other features, aspects, and advantages of the subject matter will become apparent from the description, drawings, and the claims.

### BRIEF DESCRIPTION OF THE DRAWINGS

FIG. 1 shows an example data selection system.

FIG. 2 shows an example of the operation of the data selection system of FIG. 1.

FIG. 3 shows training examples selected by the data selection system in comparison with training examples selected using other methods.

FIG. 4A shows the accuracy of models trained on the subsets of training data selected by the data selection system.

FIG. 4B shows the performance of a model trained on the subset of training data selected by the data selection system in comparison to other models.

FIG. 5 is a flow diagram of an example process of selecting a final data set for training a neural network.

FIG. 6 is a flow diagram of an example process of selecting a final data set for instruction fine-tuning a neural network.

Like reference numbers and designations in the various drawings indicate like elements.

### DETAILED DESCRIPTION

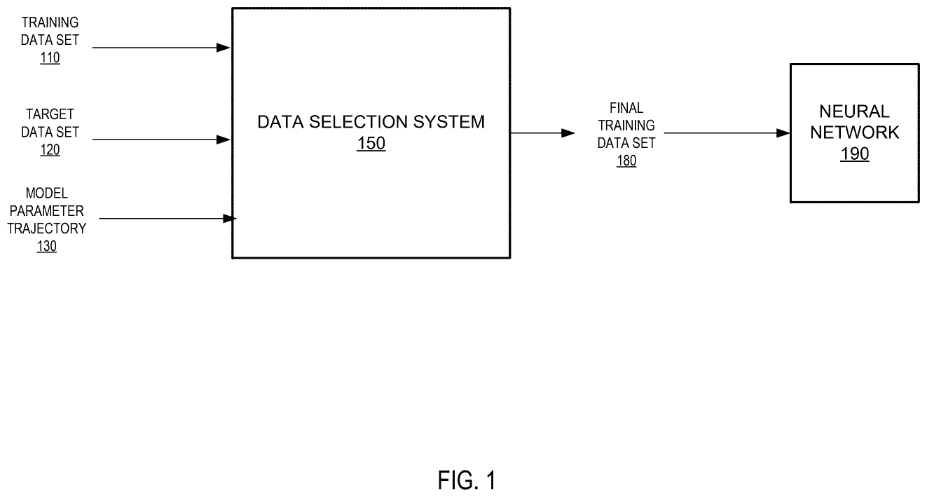

FIG. 1 shows an example data selection system 150 that selects a final training data set 180 for training a neural network. The data selection system 150 is an example of a system implemented as computer programs on one or more computers in one or more locations, in which the systems, components, and techniques described below can be implemented.

The final training data set 180 can be used to train a neural network 190. For example, the final training data set 180 can be used for instruction fine-tuning a neural network 190 that has already been pre-trained, e.g., through unsupervised learning or through another appropriate pre-training technique.

To train the neural network 190, the data selection system 150 can obtain (i) a training data set for training a neural network having parameters, (ii) a target data set for evaluating the neural network on a particular set of one or more tasks, and (iii) a model parameter trajectory.

For example, to instruction fine-tune the neural network 190, the data selection system 150 can obtain (i) a training data set for performing instruction tuning of a neural network having parameters, (ii) a target data set for evaluating the neural network on a particular set of one or more instruction following tasks and (iii) a model parameter trajectory.

The data selection system 150 can obtain the training data set 110, the target data set 120, and the model parameter trajectory 130 as input and process the input to select a final training data set 180 from the training data set 110.

The training data set 110 can include one or more training examples. For example, each training example can include a respective training input and a corresponding target output for the training input or, e.g., when training through unsupervised or semi-supervised learning, only a training input.

The target data set 120 can include one or more target examples. For example, a target example can include a respective target input and a corresponding target output for the target input, or, e.g., when training through unsupervised or semi-supervised learning, only a target input.

In some cases, the target data set 120 can include some or all of the training examples in the training data set 110, i.e., each target example can correspond to a respective one of the training examples. For example, when, after training, the neural network 190 will be used to process inputs that are in the same domain as the training inputs in the training examples, e.g., drawn from the same distribution as the training inputs, the target data set can include some or all of the training examples in the training data set. Inputs that are in the same domain can correspond, for example, to inputs with the same type of content and/or problem space. For example, a 100×100 pixel RGB image of an apple is in the same domain as a 100×100 pixel RGB image of an orange. More specifically, both are captured in the same format, e.g., both RGB, same resolution (100×100 pixel), represent the same type of object, have similar visual features, e.g., shape, texture, background, and have the same problem space, e.g., classification of fruit images. As another example, a 100×100 pixel RGB image of a banana is not in the same domain as an 80×80 pixel grayscale image of a traffic cone on a city street. More specifically, the images are not captured in the same format, e.g., RGB vs grayscale, different resolutions, do not represent the same type of object, do not have similar visual features, and do not have the same problem space, e.g., fruit images versus street/traffic images. Inputs drawn from the same distribution can correspond, for example, to inputs with consistent, or the same, statistical properties. Examples of statistical properties can include lighting conditions, background consistency, camera settings, color distribution, and noise level. For example, a 100×100 pixel RGB image of bananas taken in natural daylight can be drawn from the same distribution of 100×100 pixel images of bananas taken in natural daylight from different angles. More specifically, the inputs share similar lighting, resolution, color profiles, and object types. As another example, a 100×100 pixel RGB image of bananas taken in natural daylight is not drawn from the same distribution as 100×100 pixel RGB images of bananas taken at night under artificial lighting with motion blur. More specifically, these bananas may be the same object, but the lighting, noise, and image quality have shifted, which alters the distribution.

In some other cases, the target data set 120 includes different examples from the ones in the training data set 110, i.e., some or all of the target examples do not correspond to any of the training examples in the training data set. That is, in some cases, the examples used in the target examples are not included in the one or more training examples. For example, when, after training, the neural network 190 will be used to process inputs that are from a different domain than the training inputs in the training examples, e.g., inputs for a specific set of one or more tasks that are not well represented in the training data set 110, some or all of the target examples will not correspond to any of the training examples in the training data set 110. For example, the training data set 110 can be a general training data set that includes examples for many different tasks while the target data set 120 can evaluate the performance of the neural network 190 on one or more instruction following tasks, i.e., a task that requires processing an input that includes an instruction, e.g., a natural language instruction or a structured instruction, to generate an output that follows the instruction. Thus, in this case, the system 150 selects a subset of the training data set 110 for performing instruction tuning of the neural network for the one or more instruction following tasks. That is, the system 150 selects a subset of the training data set that includes a combined gradient trajectory that best matches the gradient trajectory of the target data set 120, which is tailored for a specific instruction following task, therefore, selecting a subset of training examples best for instruction tuning of the neural network 190 to the specific instruction task.

The model parameter trajectory 130 can include, for each time point in a sequence of time points during the training of the neural network 190, respective example values of the model parameters of the neural network 190 at the time point. That is, the model parameter trajectory 130 can represent the path the parameters of the neural network 190 take during the training of the neural network 190 as they are updated by an optimization algorithm. For example, the system or another training system can have generated the model parameter trajectory by training the neural network 190, e.g., on a smaller training data set, e.g., on a small subset of the training data set. In some implementations, selecting the smaller training data set can include randomly selecting a fixed number of training examples from the training data set. In some implementations, the neural network 190 can be trained on the smaller training data set for fewer training iterations than a number of training iterations performed during the training of the neural network 190 on the selected subset, e.g., final training data set 180. That is, the system 150 or other system can generate this trajectory in a computationally efficient manner by training on a small amount of data randomly chosen and for fewer training iterations than would typically be required for model convergence, e.g., fewer training iterations than training the neural network 190 on the final training data set 180.

The final training data set 180 can be a subset of training examples from the training data set 110. The final training data set 180 can include any number of training examples from the training data set 110. As described above, in some implementations, the final training data set 180 can represent a subset of training examples for instruction fine-tuning the neural network 190, e.g., fine-tuning the neural network on a specific instruction task. For example, the instruction task can be “translate this sentence from English to French” and the subset of training examples can include one or more training examples relating to English to French translation, e.g., an English input and a ground-truth output that is a translation of the English input into French.

The data selection system 150 can select a subset of training examples from the training data set 110 by matching gradient trajectories using the training data set 110, the target data set 120, and the model parameter trajectory 130. More specifically, the data selection system 150 can select a subset of training examples from the training data set 110 by determining the training examples in the training data set 110 with a combined gradient trajectory that best matches the gradient trajectory of the target data set 120. Selecting the final training data set will be described in more detail below.

After selection of the final training data set 180, the data selection system 150 or another training system can then train the neural network 190 on the selected subset of the training examples, e.g., final training data set 180.

In some implementations, the system 150 or another training system can perform the instruction tuning of the neural network 190 using the selected subset of the training examples, e.g., a final training data set 180.

After training the neural network on the selected subset of the training examples, e.g., final training data set 180, the system 150 or another system can receive a new input and process the new input using the neural network to generate a respective output for each of one or more of the particular set of one or more tasks.

The neural network 190 can generally be any appropriate neural network.

As one example, the neural network 190 can be a generative neural network.

For example, the generative neural network can be configured to process a conditioning input (“input prompt”) to generate a data item. Generally, the data item represents a response to the conditioning input which may be, e.g., a “prompt” for the generative neural network. For example, the conditioning input can characterize one or more desired properties for the generated data item.

In some implementations the generative neural network generates an output token sequence from an input token sequence including the conditioning input. The generative neural network may then be configured to process the input token sequence to generate for each position in the output token sequence, a respective score for each token in a vocabulary of output tokens, that is used to select an output token for the output token sequence.

In some implementations the tokens can represent text, e.g., words, wordpieces or characters, in a natural or computer language. For example, text may be received, e.g., as a series of encoded characters, e.g., UTF-8 encoded characters; such “characters” can include Chinese and other similar characters, as well as logograms, syllabograms and the like. A text encoder, i.e., a tokenizer, can process a sequence of text to represent the text as a series of text tokens from a vocabulary of text tokens, e.g., that each represent words, wordpieces or characters in a natural or computer language. The computer language may be any formal language used to communicate with a computer, e.g., a markup language, or a command or configuration language, or a data exchange language such as JSON, or a programming language. The tokenizer can, e.g., implement BPE (Byte Pair Encoding) or Wordpiece tokenization. Optionally the text can be obtained from audio data representing speech; the output tokens may be converted into audio data that represent speech corresponding to the text.

Also, or instead the tokens may represent an image. For example, a set (sequence) of input or output tokens can represent an image. Each image token may comprise a block encoding of values of the pixels in a different region of an image that maps a set of values of the pixels to a respective image token. The block encoder may comprise a neural network, e.g., having one or more (self-) attention layers, such as a Transformer neural network.

Also, or instead the tokens may represent an audio waveform. For example, a set (sequence) of input or output tokens can represent audio data representing a waveform, e.g., instantaneous audio amplitude values or time-frequency audio data. Each audio token may comprise a block encoding of the audio waveform in a different time segment of the audio that maps a set of values representing the audio waveform to a respective audio token. The block encoder may comprise a neural network, e.g., having one or more (self-) attention layers, such as a Transformer neural network.

In a multimodal system audio data or an image may be flagged by a start-of-audio token or start-of-image token.

In some implementations the generative neural network is a diffusion model neural network. In general a diffusion model neural network can be a neural network that has been trained to process a diffusion input comprising a current noisy data item and data specifying a current time to generate a diffusion output that defines an estimate (given the current time) of either a noise component of the current noisy data item, i.e., an estimate of the noise that has been added to an original data item to generate the current noisy data item; or of a de-noised version of the current noisy data item.

In some implementations the generative neural network can be a multimodal network that is configured to process a conditioning input comprising one or more of text data, audio data defining an audio signal (e.g., as amplitude values of the audio signal or as a time-frequency representation of the audio signal), or a still or moving image (e.g., as image pixel values), to generate a data item that can similarly comprise text data, audio data, or a still or moving image.

For example, the conditioning input may comprise text and the data item may comprise an image or an audio signal that represents speech or an image generated in response to the text, e.g., described by the text. Also, or instead the conditioning input may comprise an audio signal that represents speech, or an image, and the data item may comprise text, e.g., that describes the conditioning input.

As another example the conditioning input may comprise an observation, e.g., of a real world environment, e.g., from sensors such as a camera or other image sensor; and optionally additional information such as information defining a particular task to be performed. The output data item may comprise agent control data that defines one or more actions to be performed by an agent, e.g., by a mechanical agent such as a robot or autonomous vehicle, to perform a task. The reward model(s) may, e.g., define a preferred trajectory of motion of the mechanical agent in the (real-world) environment.

In some implementations the generative neural network may comprise a language and/or image generation neural network that may have been trained before being fine-tuned by the above described method. The conditioning input may comprise a prompt, e.g., a natural or computer language prompt for the generative neural network. The generated data item may comprise a natural or computer language and/or image response to the prompt.

In general, the generative neural network can have any appropriate architecture for processing the conditioning input to generate the data item.

As one example, the generative neural network may comprise an auto-regressive generative model (e.g., a Transformer, a recurrent neural network, etc.) that can auto-regressively generate an output sequence as the data item based on the conditioning input. The generative model can, for example, comprise a large language model (LLM) that can auto-regressively generate tokenized representations of text data, a vision-language model (VLM) that can auto-regressively generate tokenized representations of image or video data, e.g., in response to a text conditioning input or that can auto-regressively generate tokenized representations of text, e.g., in response to an image conditioning input, an audio language model that can auto-regressively generate tokenized representations of text data, or a multimodal model that can generate tokens representing any of text, image or audio, e.g., in response to a conditioning input comprising any of text, image or audio, and so forth.

As another example, the generative neural network may comprise a diffusion model (e.g., a denoising diffusion model, a score-based diffusion model, a latent diffusion model, etc.) that can generate the data item by repeatedly transforming samples from a noise distribution (e.g., a Gaussian distribution) based on the conditioning input over a sequence of iterations. For example, the generative neural network may comprise a diffusion model that transforms samples from the noise distribution using a denoising neural network with any appropriate architecture (e.g., a convolutional neural network, a recurrent neural network, etc.). Such a diffusion model may be used to generate, e.g., a still or moving (video) image.

As another example, the generative neural network may comprise a neural network that can generate the data item by transforming samples from a noise distribution (e.g., a Gaussian distribution). The generative neural network may comprise, e.g., a generator network of a generative adversarial network, a decoder of a variational auto-encoder, a normalizing flow, and so on.

As used herein an image may be any still or moving image, i.e., the image may be part of a video, in 2D or 3D, and may be a monochrome, color or hyperspectral image, i.e., comprising monochrome or color pixels. As defined herein an “image” includes a point cloud, e.g., from a LIDAR system, and a “pixel” includes a point of the point cloud. An image may have been captured by a camera or other image sensor from the real world; and objects in the image may comprise physical objects, represented by the image.

There is also described a computer-implemented method of generating a data item, comprising obtaining a generative neural network that has been trained as described above, obtaining a conditioning input, and processing the conditioning input using the trained generative neural network to generate the data item based on the conditioning input.

According to another aspect, there is provided a system that includes one or more computers and one or more storage devices communicatively coupled to the one or more computers and storing instructions that, when executed by the one or more computers, cause the one or more computers to perform operations of the previously described method.

According to another aspect, there is provided one or more non-transitory computer storage media storing instructions that when executed by one or more computers cause the one or more computers to perform operations of the previously described method.

In some implementations the generative neural network, e.g., a language model or a visual language model, is stored on a user computing device, i.e., a device local to the user, such as a mobile device, e.g., a mobile phone, or a smart speaker.

In some implementations the generative neural network is implemented on a remote server in communication with a user computing device over a wired or wireless network communications link between the user computing device and the server.

The user computing device may be provided with an input mechanism, such as a text or voice interface, that enables user input from the user in a natural language. The user computing device may be provided with an output mechanism that provides a system output for the user in the or another natural language, e.g., as speech or text; or in some other way, e.g., by displaying an image. The input and output mechanism may comprise, e.g., a keyboard, microphone, speaker, display, and/or camera.

As an example, the input mechanism may comprise a system configured to input audio data characterizing a speech waveform of speech representing the input from the user in a natural language, and configured to convert the audio data into tokens representing the speech in the natural language, e.g., representing a transcription of the spoken input. The output mechanism may comprise a system configured to receive tokens representing the output for the user in the or another natural language and a system configured to convert the received tokens into audio data representing a waveform of speech representing the output to the user in the natural language, i.e., representing spoken words.

As a further example, the trained system can be deployed in an environment that enables a user to provide a request for the system, e.g., to process a multimodal conditioning input to generate a corresponding data item output. A user can provide the request, e.g., by way of a user interface or through an application programming interface (API). The request can be transmitted from a user device, e.g., over a data communications network such as the internet, to one or more computers implementing the system, e.g., in a data center. The system can generate a data item and then transmit the data item to a user device over a data communications network.

The (trained) generative neural network can be used for diagnosing a fault, or for correcting undesired behavior, in a mechanical or computing system operating in the real world environment. The conditioning input may comprise a description and/or image of one or more observations of the mechanical or computing system, e.g., of operation of the system, optionally obtained from one or more sensors sensing a condition or operation of the system. An image observation may be converted into a text description, e.g., using an image captioning system or in other ways. The generated data item may comprise an image, audio, or text that identifies and/or describes a likely cause of the fault or undesired behavior. This may be used to repair the fault or correct the behavior. The reward model can define relatively more useful types of output for repairing the fault or correcting the behavior.

The (trained) generative neural network can be used for controlling a mechanical agent such as a robot or vehicle. For example, the conditioning input may comprise a description of a task to be performed, and the generated data item may comprise a list of sub-tasks to be performed by the mechanical agent (trained to perform such sub-tasks), in order to perform the task. The reward model can define relatively more preferable or useful types of sub-task.

The generative neural network may comprise a multimodal machine learning system such as a visual language model (VLM). That is, in some implementations, the generative neural network can perform a multimodal task in which the conditioning input and data item, collectively, comprise data of multiple different types. As used herein text can include numbers, punctuation, special symbols, and so forth.

In some implementations, after training, a particular task that is to be performed by the generative neural network can be described by part or all of a sequence of text in the conditioning input to the system. For example, in a conditioning input that includes an image such a prompt might specify “Generate a caption”, “Generate a description”, “Answer the following question: [about the image or video]”, or “Detect a person”. Where the system is used for an agent control task a prompt may define “Take the knife out of the drawer”, or “Q: What action should the robot take to take the knife out of the drawer?”. Also, or instead such a prompt may give one or more examples of a task to be performed. The generative neural network can be trained on multiple natural and/or computer languages and the prompt may then specify a language to use.

A few further examples of some machine learning tasks that can be performed by a system trained as described herein follow. The tasks described below may be tasks that require spatial awareness or other context from the image or video. For example, a prompt may ask “What is the object in the top left corner?”.

In general, for the tasks below the system can have been trained or fine-tuned on examples of the input and output for the task. For example, the system can have been trained using still or moving images containing one or more objects or actions, and corresponding sequences of text or other data, e.g., describing or classifying the images. However large, “foundation” models can, in general, perform some tasks zero-shot, i.e., without having been specifically trained on those tasks.

As one example the task may comprise an object or action detection task. For example, the generated data item may comprise or represent text that describes or otherwise labels detected object(s) or action(s) in a conditioning input comprising an image or audio and may include coordinates such as bounding-box coordinates for the detected object(s) or action(s), e.g., “10 20 90 100 cat 20 30 100 100 dog”.

As another example the task may comprise a classification task, e.g., an object or action classification task. The generated data item may comprise data, e.g., text, that classifies the object(s) or action(s) in represented in the conditioning data, e.g., in an image or audio, into one of a plurality of classes, or that otherwise classifies object(s) or action(s) represented in the conditioning data.

As another example the task may comprise a still or moving image describing task, e.g., a captioning task (which, as used here, includes an audio description task to explain what is happening in an image). The generated data item may comprise data, e.g., text, describing an image or video in the conditioning data. For example, the generated data item may provide a caption or description, or it may count objects in the image or video, or it may provide some other form of description.

As another example the task may comprise a still or moving image question-answering task. The generated data item may comprise data, e.g., text, that answers a question about the conditioning input, e.g., an image or audio, where the question is also specified in the conditioning input, e.g., as a sequence of text. This may be used, e.g., to answer questions about visual plots and charts or about sounds.

As another example the task may comprise a character or word recognition task, e.g., an OCR (optical character recognition) task. The conditioning input may comprise a still or moving image and the generated data item may comprise text that represents characters or words in the conditioning input, e.g., in a natural language.

As another example the task may comprise a still or moving image generation task. The generated data item may comprise image data defining values for pixels of a still or moving image, and the conditioning input, e.g., a sequence of text, may describe or characterize the image to be generated. Merely as an example, an image of a plot or chart may be generated to represent the conditioning input, e.g., comprising text.

As another example the task may comprise a computer language text generation task. The conditioning data may comprise a natural language description of a task to be performed, and optionally an image (if the task is to be performed on or in relation to an image), and the generated data item may comprise text in a computer language to perform the task, e.g., a task of analyzing the content of the image to provide a result of the analysis or to search for information relating to the content of the image.

As a particular example the computer language in the generated data item may comprise computer language for invoking a function or calling one or more external APIs. Merely as one example, such a data item may comprise data formatted as a JSON object. As previously, the conditioning input may define the task to be performed and may also include an image in relation to which the task is to be performed. In general the task can involve manipulation of particular types of data that may benefit from access to an API such as mathematical data, date/time related data, scientific data, recent data that may post-date training of the system (that may be accessed by a search function or API), and so forth; and the generated data item may comprise text in a computer language for performing the task. The method may then include using the text in the computer language to perform the task.

In general, where the generated data item comprises text, this may be converted to speech representing the text, and an audio (speech) output provided.

In some implementations the task comprises an agent control task in which the agent interacts with an environment to perform the agent control task. In these implementations the conditioning input can include an observation characterizing the environment. For example, the conditioning input can include a sequence of text that defines the task to be performed by the agent and the image can represent an observation of the environment, e.g., captured by a camera or other imaging device from a real-world environment. The generated data item can comprise an action selection output, e.g., including text, that is used to select one or more actions to be performed by the agent in the environment in response to the observation. As an illustration the generated data item may define an action as text such as “A: 132 114 128 5 25 156”, that can be converted into a control signal for a mechanical agent, such as a robot, e.g., “\mathrm{ΔT}=├[0.1,−0.2,0┤]Ξr{ΔR}=├[{10}\hat{ }o{,25}\hat{ }o,−7\hat{ }o┤]”. The action selection output may also or instead define one or more low-level skills, e.g., from a vocabulary of previously learnt skills. As before, the sequence of text in the conditioning input to the system may describe the task to be performed, e.g., “What action should the robot take to [perform task]”. Examples of systems for controlling an agent that may be fine-tuned as described herein can include PaLM-E (Driess et al. arXiv: 2303.03378), RT-1 (Brohan et al. arXiv: 2212.06817), and RT-2 (Brohan et al. arXiv: 2307.15818).

In some agent control implementations, the environment is a real-world environment, and the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot or other mechanical agent interacting with the environment to accomplish a specific task, e.g., to locate or manipulate an object of interest in the environment or to move an object of interest to a specified location in the environment or to navigate to a specified destination in the environment. In these implementations, the observations may include, e.g., one or more of: images, object position data, and sensor data to capture observations as the agent interacts with the environment. The actions may define control signals to control the robot or other mechanical agent, e.g., positions, torques, or other control signals for the parts of the mechanical agent, or higher-level control commands.

In some agent control implementations, the agent may be a human agent and the environment may be a real-world environment. For example, the agent can be a human user of a digital assistant such as a smart speaker, smart display, or some other device that is used to instruct the user to perform actions. The task may be any real-world task that the user wishes to perform. The observations may be obtained from an observation capture subsystem, e.g., a monitoring system such as a video camera or sound capture system, to capture visual observations of the user performing the task. The actions may comprise instructions in the form of, e.g., text, image, video, or audio data such as speech, that guide the user in performing the task.

In some cases, the neural network 190 may not be a generative neural network but instead be a neural network configured to perform one or more tasks that do not require generating a data item.

Some examples of such tasks follow.

The neural network system can perform any kind of machine learning task, i.e., can be configured to receive any kind of digital data input and to generate any kind of score, classification, or regression output based on the input.

In some cases, the neural network system is configured to perform an image processing task, i.e., receive an input image and to process the input image, i.e., to process intensity values of the pixels of the image, to generate a network output for the input image. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories. As another example, the task can be a depth prediction task. In a depth prediction task, the output generated by the neural network identifies, for each pixel in the image, a predicted depth of the scene at the pixel. As yet another example, the task can be a surface normal prediction task. In a surface normal prediction task, the output generated by the neural network identifies, for each pixel in the image, a predicted surface normal of the scene at the pixel.

As another example, the neural network can be configured to perform a video processing task, where the neural network receives a video that includes a sequence of input images and processes the input images, i.e., process the intensity values of the pixels of the images, to generate a network output for the video. For example, the network output can be a classification output that includes a respective score for each of multiple categories, where the categories represent, e.g., topics of the video, object categories, or action categories that each correspond to possible actions that may be being performed by entities in the video, and each score represents an estimated likelihood that the video belongs to the category. As another example, the network output can identify optical flow between pixels of the images in the video. As another example, the network output can be one or more predicted images that are predicted to follow the last image in the sequence.

As another example, if the inputs to the neural network system are Internet resources (e.g., web pages), documents, or portions of documents or features extracted from Internet resources, documents, or portions of documents, the task can be to classify the resource or document, i.e., the output generated by the neural network system for a given Internet resource, document, or portion of a document may be a score for each of a set of topics, with each score representing an estimated likelihood that the Internet resource, document, or document portion is about the topic.

As another example, if the inputs to the neural network system are features of an impression context for a particular advertisement, the output generated by the neural network system may be a score that represents an estimated likelihood that the particular advertisement will be clicked on.

As another example, if the inputs to the neural network system are features of a personalized recommendation for a user, e.g., features characterizing the context for the recommendation, e.g., features characterizing previous actions taken by the user, the output generated by the neural network system may be a score for each of a set of content items, with each score representing an estimated likelihood that the user will respond favorably to being recommended the content item.

As one example, the task may be a neural machine translation task. For example, if the input to the neural network system is a sequence of text, e.g., a sequence of words, phrases, characters, or word pieces, in one language, the output generated by the neural network system may be a translation of the sequence of text into another language, i.e., a sequence of text in the other language that is a translation of the input sequence of text. As a particular example, the task may be a multi-lingual machine translation task, where a single neural network is configured to translate between multiple different source language-target language pairs. In this example, the source language text may be augmented with an identifier that indicates the target language into which the neural network system should translate the source language text.

As another example, the task may be an audio processing task. For example, if the input to the neural network system is a sequence representing a spoken utterance, e.g., a spectrogram or a waveform or features of the spectrogram or waveform, the output generated by the neural network system may be a piece of text that is a transcript for the utterance. As another example, if the input to the neural network system is a sequence representing a spoken utterance, the output generated by the neural network system can indicate whether a particular word or phrase (“hotword”) was spoken in the utterance. As another example, if the input to the neural network system is a sequence representing a spoken utterance, the output generated by the neural network system can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram, a waveform, or other data defining audio of the text being spoken in the natural language.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be a text generation task, where the system receives a conditioning input and generates as output a sequence of text. For example, the conditioning input can be another sequence of text, e.g., so that the output sequence is a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

As another example, the task can be an image generation task, where the input is a conditioning input, and the output is a sequence of intensity values for the pixels of an image.

As another example, the task can be a computer vision task, where the input is an image or a point cloud and the output is a computer vision output for the image or point cloud, e.g., a classification output that includes a respective score for each of a plurality of categories, with each score representing the likelihood that the image or point cloud includes an object belonging to the category. When the input is an image or point cloud, the neural network system can include an embedding subnetwork that generates a respective embedding for each multiple patches of the image or point cloud, and the input to the first block of the neural network system can be a sequence that includes the respective embeddings (and, optionally, one or more additional embeddings, e.g., at a predetermined position that will later be used to generate the output). Each patch includes the intensity values of the pixels in a different region of the input image.

As another example, the task can be an agent control task, where the input is a sequence of observations or other data characterizing states of an environment, and the output defines an action to be performed by the agent in response to the most recent data in the sequence. The agent can be, e.g., a real-world or simulated robot, a control system for an industrial facility, or a control system that controls a different kind of agent.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

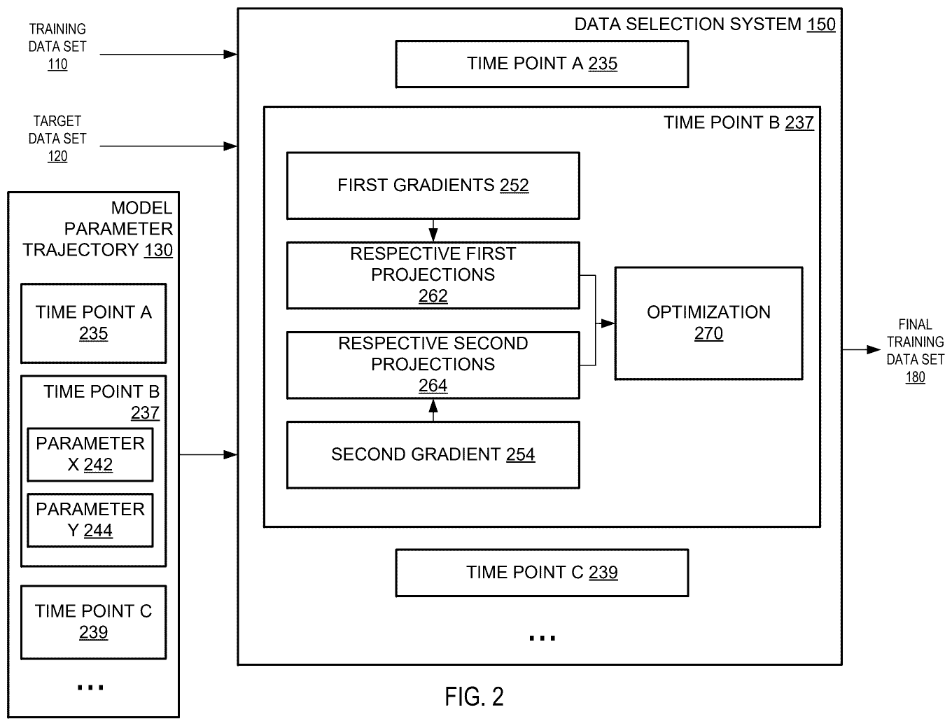

FIG. 2 shows an example of the operation of the data selection system 150 of FIG. 1. As described above, the data selection system 150 can select a subset of training examples from a training data set 110 as a final training data set 180 by matching the gradient trajectory of one or more training examples of a training data set 110 with the gradient trajectory of a target data set 120 using the model parameter trajectory 130.

To obtain the model parameter trajectory 130, the data selection system 150 can select an example subset of the training data set 110 and the data selection system 150 or another training system can train the neural network on the example subset to obtain the parameter values of the model at each of a sequence of time points in the training process.

In some implementations, the example subset of the training data set 110 can randomly select a fixed number of training examples from the training data set 110.

The data selection system 150 or another training system can train the neural network on the example subset of the training data set across one or more training iterations, where each time point of the one or more time points can correspond to a respective training iteration. For example, the model parameter trajectory 130 can include one or more time points that represent a respective training iteration, such as time point A 235 that represents a first training iteration, time point B 237 that represents a second training iteration, and time point C 239 that represents a third training iteration. The model parameter trajectory 130 can include, for each time point, or training iteration, respective example values of the model parameters at the time point. For example, time point B 237 can have an example value for parameter X 242, and an example value for parameter Y 244. The respective example values of the model parameters at the time point can be the values of the neural network parameters after the corresponding training iteration during the training of the neural network on the example subset of the training data set has been completed. For example, the value of parameter X 242 can be the value of the parameter X 242 after the second training iteration while the value of parameter Y 244 can be the value of the parameter Y after the second training iteration. That is, the data selection system 150 can capture the value of the neural network parameters, e.g., parameters X 242 and Y 244, after one or more time points during training, e.g., training iterations, to model the direction of the updates/adjustments to the parameters after each training iteration.

The data selection system 150 can process the training data set 110, the target data set 120, and the model parameter trajectory 130 to select a final training data set 180 by calculating the gradient trajectory for the training data set 110 and the target data set 120 using the model parameter trajectory 130. More specifically, the data selection system 150 can determine a subset of the training examples of the training data set 110 that best match the gradient trajectory of the target data set. To determine the gradient trajectories of the training examples, the data selection system 150 can determine gradients for the examples, e.g., training and target, with respect to the model parameter trajectory 130 at each time point in the trajectory 130.

For each time point in the sequence of time points, the data selection system 150 can perform the one or more below actions to determine the gradient trajectories of the training examples and target examples.

The data selection system 150 can determine first gradients 252 for the training examples in the training data set 110 with respect to the model parameters at the time point. That is, for each time point in the sequence of time points, the system 150 can determine a respective first gradient for each training example of the training data set 110 with respect to the model parameters for the time point, e.g., in accordance with the respective example values of the model parameters at the time point. In particular, the data selection system 150 can calculate the value of an objective function for each training example when the model parameters have the values at the corresponding time point and compute the gradient of the objective function with respect to the model parameters at the time point. For example, at time point B 237, the data selection system 150 can calculate the value of a loss function for a particular training example and then compute the gradient of that loss with respect to the values of parameter X 242 and parameter Y 244 at time point B 237. The objective function is described in more detail below.

The data selection system 150 can also determine a second gradient 254 of the target data set 120 with respect to the model parameters at the time point. Similarly to above, the system 150 can determine, in accordance with the respective example values of the model parameters at the time point, a second gradient 254 of the target data set 120 with respect to the model parameters for the time point. In particular, the data selection system 150 can determine, in accordance with the respective example values of the model parameters at the time point, a respective initial second gradient of each target examples in the target data set 120 with respect to the model parameters and then combine the respective initial second gradients to generate the second gradient 254 for the target data set 120. In other words, a second gradient 254 can be computed for the target data set 120 as a combination of one or more initial second gradients of the one or more target examples. That is, the data selection system 150 can determine a singular second gradient 254 that characterizes/captures the one or more initial second gradients of each target example to represent a consensus/average direction for the one or more gradients of the one or more target examples of the target data set 120. The one or more initial second gradients can be combined using any method. For example, the one or more initial second gradients can be averaged to generate an (average) second gradient of the target data set 120.

The data selection system 150 can then determine respective gradient trajectories for the training examples of the training data set 110 using the first gradients 252 and the second gradient 254. The data selection system 150 can determine a respective first projection of each of the first gradients 252 onto a respective subspace for the time point. The data selection system 150 can also determine a second projection of the second gradient for the time point onto the respective subspace for the time point. That is, for each time point, the data selection system 150 can project the first gradients of the one or more training examples of the training data set 110 and the second gradient of the target data set 120 onto a respective subspace for the time point to enable easier objective comparison of the gradients to determine how well a gradient of a training example aligns with the target gradient.

At any given time, point, the respective subspace for the time point can provide information about gradients of target examples with respect to the model parameters and in accordance with the respective example values of the model parameters at the time point. In other words, the respective subspace can characterize the one or more gradients of target examples of the target data set 120 for the time point.

The data selection system 150 can determine one or more subspaces for the one or more time points in the sequence of time points. In particular, for each time point in the sequence of time points, the data selection system 150 can determine the respective subspace for the time point. The data selection system 150 can determine the respective subspace using any appropriate method. In some implementations, the data selection system 150 can determine the respective subspace for the time point from at least some of the respective initial second gradients for the time point. For example, the data selection system 150 can determine principal components of a matrix of at least some of the initial second gradients and select, as the respective subspace for the time point, a top K orthogonal basis of the principal components.

The data selection system 150 can then select a subset of the training data set 110 as a final training data set for training the neural network using the first and second projections for the time point. More specifically, the data selection system 150 can select the subset of training examples that best matches the gradient of the target dataset, e.g., the second projection, in the subspace.

The data selection system 150 can select a subset of the training data set as a final training data set 180 for training the neural network by performing an optimization. For example, the data selection system 150 can perform an optimization to identify a subset of the training data set that minimizes an error between (i) a target set including the second projections for time points and (ii) a training set of weighted first projections for the time points. The weighted first projection for each of the time points can be a weighted combination of the respective first projections for the time point in accordance with respective weights for each of the training examples. For example, the weighted combination of the respective first projections 262 of the time point can be a weighted sum of the respective first projections 262 for the training examples. In particular, the data selection system 150 can select the subset by performing an optimization to identify a subset of the training data set 110 that minimizes the error between (i) a second set of the second projections for each of the time points and (ii) a first set of weighted first projections for each of the time points subject to a constraint on an L0 norm of the respective weights for the training examples, e.g., that ensures that the subset includes only a smaller number of the training examples in the training data set. In particular, the L0 norm can enforce sparsity to minimize the amount of training examples used by adding a penalty to the loss function that discourages non-zero weights. The training examples with final weights that are non-zero are included in the final training data set 180 while training examples with a weight that is zero are not included in the final training subset.

The objective function can be represented by the equation below, where the L(S) is the summation of the per-step matching loss (Lₜ(S)), U^{t}·∇_{θ}_{^{t}} log p(θ^{t}|Dₜₐᵣ) represents the second projections of the target data set 120, and

$${\sum }_{i = 1}^{N} {w}_{i} {U}^{t} ∘ {∇}_{{θ}^{t}} log p ( ( {x}_{i} , {y}_{i} ) ; {θ}^{t} )$$

represents the weighted first projections subject to a constraint (∥w∥₀):

$${L}_{t} ( S ) = {\sum }_{t} {‖ {U}^{t} ∘ {∇}_{{θ}^{t}} log p ( {θ}^{t} \vert {D}_{tar} ) - {\sum }_{i = 1}^{N} {w}_{i} {U}^{t} ∘ {∇}_{{θ}^{t}} log p ( ( {x}_{i} , {y}_{i} ) ; {θ}^{t} ) ‖}_{2} + {‖ w ‖}_{0}$$

As demonstrated by the equation below, the data selection system 150 can optimize a loss function that computes the error between the projections of the gradient vectors (log p(θ^{t}|Dₜₐᵣ) of the target data set 120 (D_{tar}) on a subspace U^{t} and the weighted projections of the gradients of the training examples

$$( {w}_{i {∇}_{{θ}^{t}}} log p ( ( {x}_{i} , {y}_{i} ) ; {θ}^{t} ) ) ,$$

where the weight wₜ of each data point is regularized through a L0 norm (∥w∥₀). At a high level, the data selection system 150 can determine a subset of the training examples of the training data set 110 whose gradients best match the gradient trajectory of the target data set 120, e.g., has the smallest error.

The data selection system 150 can perform the optimization using any appropriate method. In some implementations, the data selection system 150 can perform the optimization by performing an orthogonal matching pursuit algorithm. In some implementations, the data selection system 150 can perform the optimization by performing a bounded version of the orthogonal matching pursuit algorithm. The bounded version of the orthogonal matching pursuit algorithm can include jointly selecting 2M top data points all at once, calculating a non-negative least square to adjust the weights, e.g., implicit de-duplication, and then re-ranking and choosing the top M samples to update a residual vector in the orthogonal matching pursuit algorithm. That is, the orthogonal matching pursuit algorithm can jointly select the top 2×M training examples, where M is the number of training examples in the final training data set 180, de-duplicate the training examples and adjust the weights and then re-rank the training examples to choose the top M training examples to be included in the final training data set 180. As described above, M can be a variable denoting the number of training examples in the final training data set 180 (e.g., 20, 50, 100). The value of M can be any appropriate number. In some implementations, the value of M can be preconfigured, e.g., set before the data selection process. In some implementations, the value of M can be dependent on the input (e.g., domain, distribution) and/or the specific task on which the neural network is being trained. At a high level, the optimization process of the objective function can be equivalent to starting from a top-k initialization of the training examples and iteratively determining the proper combination of training examples while implicitly performing de-duplication to remove any duplicate training examples by adjusting the weights of the training examples.

By performing the above process, the data selection system 150 can select a subset that is drastically smaller than the training data but, when used to train the neural network results in a trained neural network that performs comparably to or even better than a neural network trained on the entire training data set, i.e., on the one or more tasks that the target data set is designed to evaluate. That is, because the selected subset is drastically smaller, the training of the neural network consumes significantly fewer computational resources, e.g., processor cycles and memory, while still yielding a trained neural network that has the same or better performance.

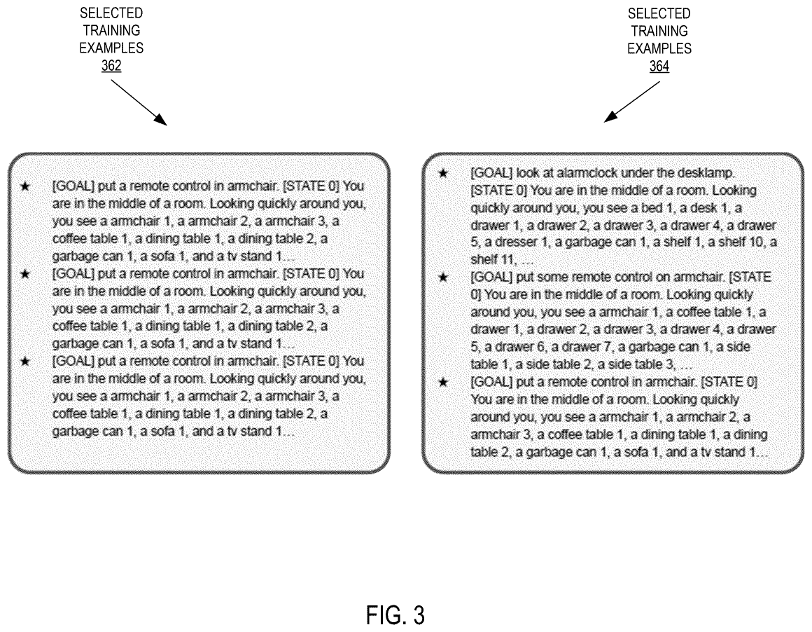

FIG. 3 shows training examples selected by the data selection system in comparison with training examples selected using other methods. More specifically, FIG. 3 illustrates the diversity of the selection training examples 364 chosen by the data selection system described in this disclosure, e.g., the data selection system 150 of FIG. 1, compared to selected training examples 362 traditional data selection techniques. While the training examples are being utilized to train the model on a specific task and too much diversity would broaden the task of the model too much, task-relevant diversity in the examples helps train a more robust model that can better generalize to new, unseen data. The use of identical training examples negatively affects the quality of the output of the model.

In particular, the selected training examples 362 illustrate the repetitiveness of using a top-k selection technique, while the selected training examples 364 illustrate the high quality, diverse examples chosen using our matching gradient-trajectory techniques. As seen in FIG. 3, the selected training examples 362 are the same exact training examples, while the selected training examples 364 can include different prompts (e.g., goals) for the training examples and different outputs (e.g., states). Thus, the data selection system 150 can generate high quality, diverse training examples to train a neural network on a specific task.

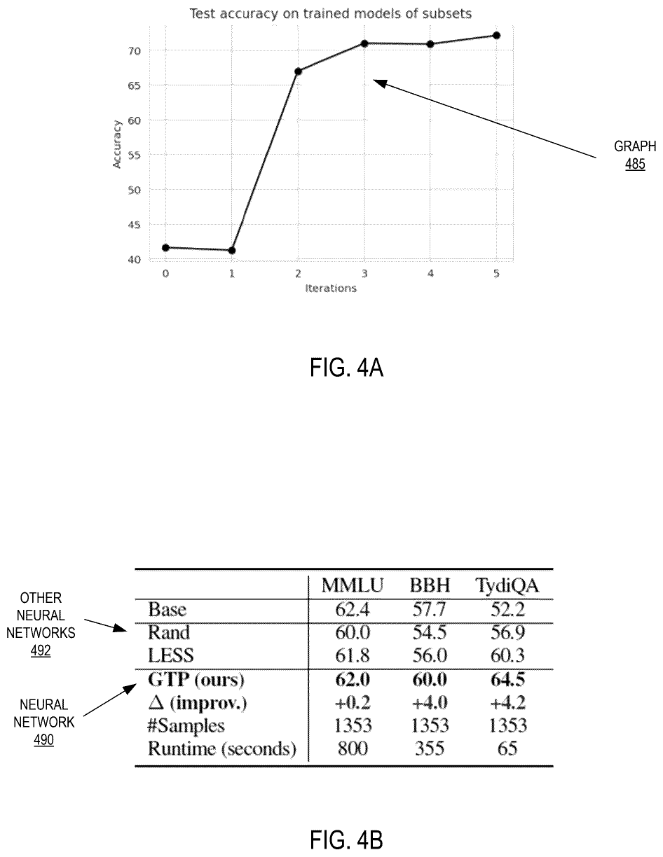

FIG. 4A shows the accuracy of models trained on the subsets of training data selected by the data selection system 150.

The graph in FIG. 4A demonstrates the test accuracy of a neural network trained on a subset of training data selected by the data selection system 150 of FIG. 1. In particular, the graph demonstrates the accuracies of subsets of 1000 samples after each training iteration of the model using the subset of training data. The initial step of the training sequence is equivalent to a top-k selection technique, and later iterations can be seen as a process of de-duplication through adjusting the data weights w in the optimization function (as described above in more detail with reference to FIG. 2).

At a high level, the graph of the accuracy of a neural network trained on the selected subset of training data by the data selection system 150 demonstrates the superior performance of the techniques over a top-k selection technique (e.g., the strength of using task-diverse training examples) and the overall high accuracy of the neural network trained on the selected subset of training data.

FIG. 4B shows the performance of a neural network 490 trained on the subset of training data selected by the data selection system in comparison to one or more other neural networks 492.

In particular, FIG. 4B compares the performance of the neural network 490, e.g., the neural network 190 of FIG. 1, trained on the subset of training data selected by the data selection system 150 of FIG. 1 as described in this specification to the performance of the one or more other neural networks 492 trained on prior methods of training data selection.

The neural network 490 and the one or more other neural networks 492 are evaluated on three benchmarks: MMLU, BBH, and TydiQA.

The massive multitask language understanding (MMLU) benchmark can be referred to as the “de-facto” benchmark for evaluating the capability of large language models on 57 subsets of training data across elementary mathematics, humanities, law, social sciences and more. That is, the MMLU benchmark is designed to test general knowledge and reasoning of a neural network across a wide range of subjects to assess how well a model can generalize across domains.

The big-bench hard (BBH) benchmark can evaluate the reasoning capability of large language models. The BBH can be curated as a subset of the big-bench benchmark, focusing on 27 tasks where current models struggle to match human performance. The BBH can include tasks that require logical reasoning, multi-step inference and compositional generalization to assess how LLMs do on the hardest of the big-bench tasks.

The typologically diverse question answering (TyDiQA) benchmark is a multilingual question-answering benchmark covering 11 diverse languages, and features questions from native speakers seeking answers. That is, the TyDiQA benchmark can be a question answering benchmark designed to test models on typologically diverse languages to focus on cross-lingual and multilingual QA performance for neural networks.

As demonstrated in FIG. 4B, over all three benchmarks, the neural network 490 trained on a training data set selected according to the techniques described in this specification can outperform one or more other neural networks 492 trained on data sets selected by prior methods. For example, the neural network 490 can outperform the other models by 0.2% on MMLU, 4% on BBH and 4.2% on TyDiQA. Furthermore, the neural network 490 is trained on 0.5% of the full data, achieving a 10× reduction on the selected subset size while achieving better results.

That is, the neural network 490 can outperform the one or more other neural networks 492, all while using 10× less training examples, saving significant levels of compute and memory.

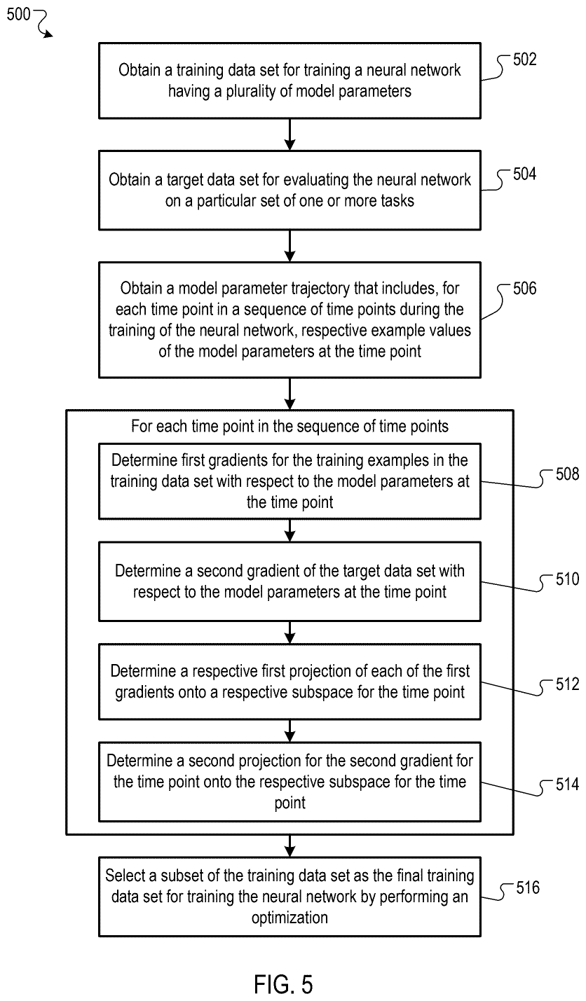

FIG. 5 is a flow diagram of an example process of selecting a final data set for training a neural network.

For convenience, the process 500 will be described as being performed by a system of one or more computers located in one or more locations. For example, a training system, e.g., the training system 100 depicted in FIG. 1, appropriately programmed in accordance with this specification, can perform the process 500.

The system can obtain a training data set for training a neural network having one or more model parameters (step 502). The training data set can include one or more training examples. For example, each training example can include a respective training input and a corresponding target output for the training input or, e.g., when training through unsupervised or semi-supervised learning, only a training input.

The system can obtain a target data set for evaluating the neural network on a particular set of one or more tasks (step 504). The target data set can include one or more target examples. For example, a target example can include a respective target input and a corresponding target output for the target input, or, e.g., when training through unsupervised or semi-supervised learning, only a target input. The target data set can include some or all of the training examples in the training data set, i.e., each target example can correspond to a respective one of the training examples. For example, when, after training, the neural network will be used to process inputs that are in the same domain as the training inputs in the training examples, e.g., drawn from the same distribution as the training inputs, the target data set can include some or all of the training examples in training data set.

The system can obtain a model parameter trajectory that includes, for each time point in a sequence of time points during the training of the neural network, respective example values of the model parameters at the time point (step 506). The model parameter trajectory can include, for each time point in a sequence of time points during the training of the neural network, respective example values of the model parameters of the neural network at the time point. That is, the model parameter trajectory can represent the path the parameters of the neural network take during the training of the neural network as they are updated by an optimization algorithm. For example, the system or another training system can have generated the model parameter trajectory by training the neural network, e.g., on a smaller training data set, e.g., on a small subset of the training data set as described in further detail with reference to FIG. 2.

The below described steps (steps 508-514) can be performed for each time point in the sequence of time points.

The system can determine the first gradients for the training examples in the training data set with respect to the model parameters at the time point (step 508). As described above with reference to FIG. 2, the system can determine first gradients for each of the training examples in the training data set according to the respective example values of the model parameters at the time point.

The system can determine a second gradient of the target data set with respect to the model parameters at the time point (step 510). As described above with reference to FIG. 2, the system can determine the second gradient of the target data set according to the respective example values of the model parameters at the time point by combining initial second gradients of each target example of the target data set with respect to the model parameters at the time point.

The system can determine a respective first projection of each of the first gradients onto a respective subspace for the time point (step 512). As described above with reference to FIG. 2, the system can project the one or more first gradients onto a respective subspace for the time point, where the subspace is determined from at least some of the respective initial second gradients for the time point.

The system can determine a second projection of the second gradient for the time point onto the respective subspace for the time point (step 514). As described above with reference to FIG. 2, can project the second gradient onto a respective subspace for the time point, where the subspace is determined from at least some of the respective initial second gradients for the time point.

The system can then select a subset of the training data set as a final training data set for training the neural network by performing an optimization (step 516). In particular, the system can perform an optimization to identify a subset of the training data set that minimizes an error between (i) a target set including the second projections for time points and (ii) a training set of weighted first projections for the time points. The weighted first projection for each of the time points can be a weighted combination of the respective first projections for the time point in accordance with respective weights for each of the training examples. The optimization is described in further detail above with reference to FIG. 2.

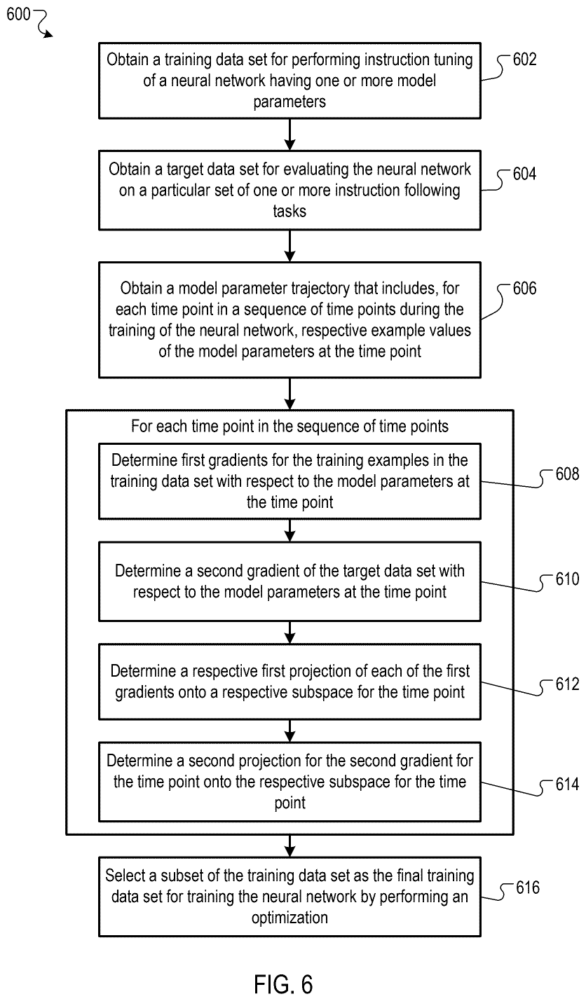

FIG. 6 is a flow diagram of an example process of selecting a final data set for instruction fine-tuning a neural network.

For convenience, the process 600 will be described as being performed by a system of one or more computers located in one or more locations. For example, a system, e.g., the system 100 depicted in FIG. 1, appropriately programmed in accordance with this specification, can perform the process 600.

The system can obtain a training data set for performing instruction tuning of a neural network having one or more parameters (step 602). The training data set can include one or more training examples. For example, each training example can include a respective training input and a corresponding target output for the training input or, e.g., when training through unsupervised or semi-supervised learning, only a training input.

The system can obtain a target data set for evaluating the neural network on a particular set of one or more instruction following tasks (step 604). The target data set can include one or more target examples. The target data set can include one or more target examples. The target data set can include one or more target examples. For example, a target example can include a respective target input and a corresponding target output for the target input, or, e.g., when training through unsupervised or semi-supervised learning, only a target input.

The target data set includes different examples from the ones in the training data set, i.e., some or all of the target examples do not correspond to any of the training examples in the training data set. That is, in some cases, the examples used in the target examples are not included in the one or more training examples. For example, when, after training, the neural network will be used to process inputs that are from a different domain than the training inputs in the training examples, e.g., inputs for a specific set of one or more tasks that are not well represented in the training data set, some or all of the target examples will not correspond to any of the training examples in the training data set. For example, the training data set can be a general training data set that includes examples for many different tasks while the target data set can evaluate the performance of the neural network on one or more instruction following tasks, i.e., a task that requires processing an input that includes an instruction, e.g., a natural language instruction or a structured instruction, to generate an output that follows the instruction. Thus, in this case, the system selects a subset of the training data set for performing instruction tuning of the neural network for the one or more instruction following tasks.

The system can obtain a model parameter trajectory that includes, for each time point in a sequence of time points during the training of the neural network, respective example values of the model parameters at the time point (step 606). The model parameter trajectory can include, for each time point in a sequence of time points during the training of the neural network, respective example values of the model parameters of the neural network at the time point. That is, the model parameter trajectory can represent the path the parameters of the neural network take during the training of the neural network as they are updated by an optimization algorithm. For example, the system or another training system can have generated the model parameter trajectory by training the neural network, e.g., on a smaller training data set, e.g., on a small subset of the training data set as described in further detail with reference to FIG. 2.

The below described steps (steps 608-614) can be performed for each time point in the sequence of time points.

The system can determine the first gradients for the training examples in the training data set with respect to the model parameters at the time point (step 608). As described above with reference to FIG. 2, the system can determine first gradients for each of the training examples in the training data set according to the respective example values of the model parameters at the time point.

The system can determine a second gradient of the target data set with respect to the model parameters at the time point (step 610). As described above with reference to FIG. 2, the system can determine the second gradient of the target data set according to the respective example values of the model parameters at the time point by combining initial second gradients of each target example of the target data set with respect to the model parameters at the time point.

The system can determine a respective first projection of each of the first gradients onto a respective subspace for the time point (step 612). As described above with reference to FIG. 2, the system can project the one or more first gradients onto a respective subspace for the time point, where the subspace is determined from at least some of the respective initial second gradients for the time point.

The system can determine a second projection of the second gradient for the time point onto the respective subspace for the time point (step 614). As described above with reference to FIG. 2, can project the second gradient onto a respective subspace for the time point, where the subspace is determined from at least some of the respective initial second gradients for the time point.

The system can then select a subset of the training data set as a final training data set for training the neural network by performing an optimization (step 616). In particular, the system can perform an optimization to identify a subset of the training data set that minimizes an error between (i) a target set including the second projections for time points and (ii) a training set of weighted first projections for the time points. The weighted first projection for each of the time points can be a weighted combination of the respective first projections for the time point in accordance with respective weights for each of the training examples. The optimization is described in further detail above with reference to FIG. 2.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them.

Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are corresponded to in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes corresponded to in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining a training data set for training a neural network having a plurality of model parameters, the training data set comprising a plurality of training examples;
obtaining a target data set for evaluating the neural network on a particular set of one or more tasks, the target data set comprising a plurality of target examples;
obtaining a model parameter trajectory that comprises, for each time point in a sequence of time points during the training of the neural network, respective example values of the model parameters at the time point;
for each time point in the sequence of time points:
determining first gradients for the training examples in the training data set with respect to the model parameters at the time point;
determining a second gradient of the target data set with respect to the model parameters at the time point;
determining a respective first projection of each of the first gradients onto a respective subspace for the time point;
determining a second projection of the second gradient for the time point onto the respective subspace for the time point; and
selecting a subset of the training data set as a final training data set for training the neural network by performing an optimization to identify a subset of the training data set that minimizes an error between (i) a target set comprising the second projections for time points and (ii) a training set of weighted first projections for the time points, wherein the weighted first projection for each of the time points is a weighted combination of the respective first projections for the time point in accordance with respective weights for each of the training examples.

2. The method of claim 1, wherein each of the target examples corresponds to one of the training examples.

3. The method of claim 1, wherein the target examples are not included in the plurality of training examples.

4. The method of claim 1, further comprising:
training the neural network on the selected subset of the training examples.

5. The method of claim 4, further comprising:
after training the neural network on the selected subset of the training examples:
receiving a new input; and
processing the new input using the neural network to generate a respective output for each of one or more of the particular set of one or more tasks.

6. The method of claim 1, wherein determining a second gradient of the target data set with respect to the model parameters comprises:
determining, in accordance with the respective example values of the model parameters at the time point, a respective initial second gradient of each target example in the target data set with respect to the model parameters; and
combining the respective initial second gradients to generate the second gradient.

7. The method of claim 1, wherein obtaining a model parameter trajectory that comprises, for each time point in a sequence of time points during the training of the neural network, respective example values of the model parameters at the time point comprises:
selecting an example subset of the training data set; and
training the neural network on the example subset of the training data set across a plurality of training iterations, wherein each time point corresponds to a respective training iteration and wherein the respective example values of the model parameters at the time point are values of the model parameters after the corresponding training iteration during the training of the neural network on the example subset of the training data set has been completed.

8. The method of claim 7, wherein each time point corresponds to a respective training epoch during the training of the neural network on the example subset of the training data set.

9. The method of claim 7, wherein selecting an example subset of the training data set comprises randomly selecting a fixed number of training examples from the training data set.

10. The method of claim 7, when dependent on claim 4, wherein the neural network is trained on the example subset of the training data for fewer training iterations than a number of training iterations performed during the training of the neural network on the selected subset.

11. The method of claim 1, further comprising:
for each time point in the sequence of time points:
determining the respective subspace for the time point.

12. The method of claim 11, when dependent on claim 6, wherein determining the respective subspace for the time point comprises:
determining the respective subspace for the time point from at least some of the respective initial second gradients for the time point.

13. The method of claim 12, wherein determining the respective subspace for the time point from the respective initial second gradients for the time point comprises:
determining principal components of a matrix of at least some of the initial second gradients; and
selecting, as the respective subspace for the time point, a top K orthonormal basis of the principal components.

14. The method of claim 1, wherein the optimization identifies a subset of the training data set that minimizes an error between (i) the second set of the second projections for each of the time points and (ii) the first set of weighted first projections for each of the time points subject to a constraint on an L0 norm of the respective weights for the training examples.

15. The method of claim 14, wherein performing the optimization comprises performing an orthogonal matching pursuit algorithm.

16. The method of claim 15, wherein performing the optimization comprises performing a bounded version of the orthogonal matching pursuit algorithm.

17. The method of claim 1, wherein, prior to selecting the subset, the neural network has been trained on one or more initial sets of training data.

18. A method performed by one or more computers, the method comprising:
receiving a new network input; and
processing the new network input using a neural network to generate a new network output, wherein the neural network has been trained on a final training data set that has been generated by performing the operations comprising:
obtaining a training data set for training a neural network having a plurality of model parameters, the training data set comprising a plurality of training examples;
obtaining a target data set for evaluating the neural network on a particular set of one or more tasks, the target data set comprising a plurality of target examples;
obtaining a model parameter trajectory that comprises, for each time point in a sequence of time points during the training of the neural network, respective example values of the model parameters at the time point;
for each time point in the sequence of time points:
determining first gradients for the training examples in the training data set with respect to the model parameters at the time point;
determining a second gradient of the target data set with respect to the model parameters at the time point;
determining a respective first projection of each of the first gradients onto a respective subspace for the time point;
determining a second projection of the second gradient for the time point onto the respective subspace for the time point; and
selecting a subset of the training data set as a final training data set for training the neural network by performing an optimization to identify a subset of the training data set that minimizes an error between (i) a target set comprising the second projections for time points and (ii) a training set of weighted first projections for the time points, wherein the weighted first projection for each of the time points is a weighted combination of the respective first projections for the time point in accordance with respective weights for each of the training examples.

19. The method of claim 1, wherein training the neural network comprises instruction tuning the neural network after the NN has been pre-trained.

20. The method of claim 19, further comprising:
performing the instruction tuning of the neural network using the selected subset of the training examples.

21. The method of claim 1, wherein the neural network is a generative neural network that generates an output token sequence from an input token sequence including the input prompt, and wherein the generative neural network is configured to process the input token sequence to generate for each position in the output token sequence, a respective score for each token in a vocabulary of output tokens.

22. The method of claim 1, wherein the neural network is a generative neural network that processes an input prompt to generate, as output, a data item.

23. The method of claim 22, wherein the data item comprises a language and/or image and/or audio response to the prompt.

24. The method of claim 22, wherein the data item comprises an image or audio response to the prompt.

25. The method of claim 22, wherein the input prompt comprises an input image and wherein the output data item is a classification data item that identifies a label for an object class to which the input belongs, and wherein the object class corresponds to a class of object depicted in the input image.

26. A system comprising:
one or more computers; and
one or more storage devices communicatively coupled to the one or more computers, wherein the one or more storage devices store instructions that, when executed by the one or more computers, cause the one or more computers to perform the operations comprising:
obtaining a training data set for performing instruction tuning of a neural network having a plurality of model parameters, the training data set comprising a plurality of training examples;
obtaining a target data set for evaluating the neural network on a particular set of one or more instruction following tasks, the target data set comprising a plurality of target examples;
obtaining a model parameter trajectory that comprises, for each time point in a sequence of time points during the training of the neural network, respective example values of the model parameters at the time point;
for each time point in the sequence of time points:
determining first gradients for the training examples in the training data set with respect to the model parameters at the time point;
determining a second gradient of the target data set with respect to the model parameters at the time point;
determining a respective first projection of each of the first gradients onto a respective subspace for the time point;
determining a second projection of the second gradient for the time point onto the respective subspace for the time point; and
selecting a subset of the training data set as a final training data set for training the neural network by performing an optimization to identify a subset of the training data set that minimizes an error between (i) a target set comprising the second projections for time points and (ii) a training set of weighted first projections for the time points, wherein the weighted first projection for each of the time points is a weighted combination of the respective first projections for the time point in accordance with respective weights for each of the training examples.
